(19) United States
(12) Patent Application Publication
(10) Pub. No.: US 2003/0202271 A1
(43) Pub. Date: Oct. 30, 2003

(54) Method for controlling and protecting computer facility

(76) Inventor: Jack Chen, Taichung (TW)

Correspondence Address: CHARLES E. BAXLEY, 59 John Street-5th Floor, New York, NY, 10038, US

(21) Appl. No.: 10/133,901

(22) Filed: Apr. 29, 2002

(51) Int. Cl. G11B 5/02

(52) U.S. Cl. 360/55

(57) ABSTRACT

A method for protecting the original information in a disc includes a visual CPU disposed or arranged before the disc, for allowing users to enter into the visual CPU before entering into the disc, and for allowing the users to operate the disc without the operating system of the disc. The original information in the disc may be copied or stored into a spare area as stored information, which may then be copied over the original information before entering into the disc, particularly after the information in the disc has been damaged by various kinds of computer viruses.

### BACKGROUND OF THE INVENTION

1. Field of the Invention

The present invention relates to a method, and more particularly to a method for controlling and protecting the files or information of the discs of the computer facilities.

2. Description of the Prior Art

Various kinds of computer viruses have been developed for attacking or damaging the computer facilities today, and many more computer viruses have been further developed everyday. Not only the personal computers may be damaged by the computer viruses, but also many large computer facilities or systems may be is damaged or become fail by the computer viruses. For example, the computer systems of the whole company, or of the airplanes, or of the defensive systems of the countries, etc., may all be damaged by computer viruses easily and quickly.

At present, almost all of the computer facilities comprise one or more hard discs provided therein and having the operating programs or systems provided therein for operating the computer facilities, and for allowing the users to enter into and to operate the discs right after the computer facilities have been energized.

However, for example, when the discs or the files of the computer facilities have been attacked and/or damaged by any kind of computer viruses, the discs may be become fail, and the users normally may not be entered into the operating systems that are stored in the discs, and thus may not operate the discs of the computer facilities. The files and the information in the discs may thus be damaged and may no longer be used again.

The present invention has arisen to mitigate and/or obviate the afore-described disadvantages of the conventional computer facilities controlling methods.

### SUMMARY OF THE INVENTION

The primary objective of the present invention is to provide a method for controlling and protecting the files or information of the discs of the computer facilities.

The other objective of the present invention is to provide a method for rescuing the information of files or in discs or the like after the disks or files have been damaged by the computer viruses.

In accordance with one aspect of the invention, there is provided a method for protecting original files or data or information in a disc, the method comprising providing a visual CPU before the disc, and entering into the visual CPU before entering into the disc, for allowing the users to operate the disc without the original operating system provided in the disc, and for allowing the users to operate the disc after the information in the disc has been attacked or damaged by various kinds of computer viruses.

The original files or data or information in the disc may be copied into a spare area as a spare data or information, for further use. The stored files or data or information may then be copied onto or over the original files or data or information before entering into the disc, or after or when the original files or data or information in the disc has been attacked or damaged by various kinds of computer viruses.

One or more operating systems, and/or one or more buffers, and/or one or more data stack regions, and/or one or more acceleration transmission regions may be formed or defined or created before entering into the disc, particularly when the original files or data or information in the disc has been attacked or damaged by various kinds of computer viruses.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a flow chart illustrating the processes of a method in accordance with the present invention, for controlling and protecting the files or information of the discs of the computer facilities.

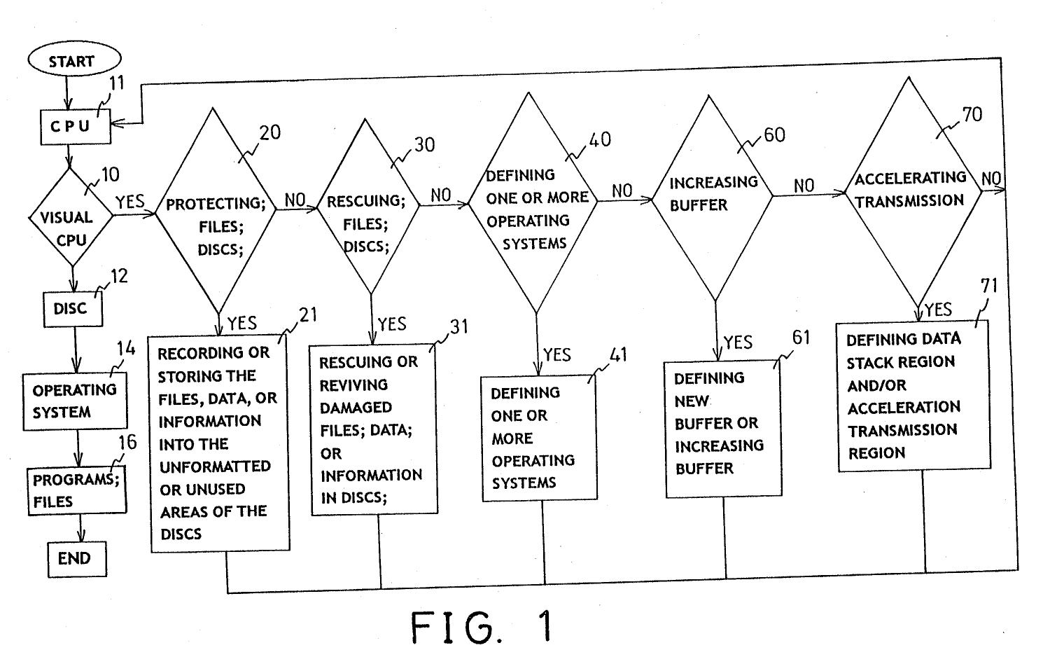

### DETAILED DESCRIPTION OF THE PREFERRED EMBODIMENT

Referring to the drawing, illustrated is a flow chart for showing the processes of a method in accordance with the present invention. The method comprises a visual central processing unit (visual CPU) 10 to be provided and arranged between the CPU 11 and the discs 12 of the computer facilities, for allowing the files and/or the information in the discs 12 of the computer facilities to be entered and operated only after entering through the visual CPU 10, and for allowing the operating systems 14 and/or the files and/or the information 16 in the discs 12 to be entered and operated only after the users have entered into the discs 12.

For example, before or after entering into the discs 12 of the computer facilities, the users may enter into a discs and/or files protecting mode 20 via the visual CPU 10, in order to record or to copy or to store the files, the data, or the information in the discs into the unformatted or unused areas of the discs, or into the other hard discs and/or floppy discs, or into the other spare areas, as the spare information, in the process 21. Normally, the discs may each include one or more concentric circles as the usable areas, and one or more unused areas formed alternatively between the concentric circles where the typical disc operating systems may not be entered. The method for entering into the unusable areas has been filed in the co-pending U.S. patent application Ser. No. 09/726,167, filed on Nov. 29, 2000, which is taken as a reference for the present invention.

Before entering into the discs 12 of the computer facilities, the users may also enter into a discs-and/or-files rescuing mode 30 via the visual CPU 10, before or after the protecting mode 20. For example, the files, the data, or the information in the discs may have been damaged by the computer viruses. However, the files, the data or the information may have previously been stored in the unformatted or unused areas of the discs or in the other hard discs and/or floppy discs in the protecting mode 20, before the discs have been damaged. The files, the data or the information that have been previously stored and/or protected in the unformatted or unused areas of the discs or in the other hard discs and/or floppy discs may then be copied and/or formatted and/or covered over the damaged files and/or discs, in order to rescue or to revive the damaged files and/or data, and/or information in the discs in the process 31.

Accordingly, the damaged files or information or discs may be covered by the newly copied files or information, for preventing the users from entering into the damaged files or discs. Or, when the users knew that the files and/or the discs have been attacked or damaged by the computer viruses, the users may turn off the computer facility right away, and may re-energize or re-open the computer facility again, in order to enter into the visual CPU 10 without entering into the damaged discs, and in order to copy the stored files and/or data and/or information onto the damaged files and/or data and/or information of the discs, and so as to rescue or to revive the damaged discs.

Before entering into the discs 12 of the computer facilities, the users may also enter into an operating system defining mode 40 via the visual CPU 10, before or after the protecting mode 20 and/or the discs-and/or-files rescuing mode 30. For example, after entering into the operating system defining mode 40, the users may defining one or more operating systems in the process 41, in order to supersede the previous operating systems in the discs that may have been attacked or damaged by the computer viruses.

Before entering into the discs 12 of the computer facilities, the users may also enter into a buffer increasing mode 60 via the visual CPU 10, before or after the protecting mode 20 and/or the discs-and/or-files rescuing mode 30 and/or the operating system defining mode 40. For example, after entering into the buffer increasing mode 60, the users may define one or more new buffers or may increase the buffers in the process 61, in order to supersede the previous buffers in the discs that may have been attacked or damaged by the computer viruses.

For example, in the buffer increasing mode 60, the users may divide the hard disc into two or more areas, and may have one or more of the divided areas that may not be entered by any unauthorized persons. The data or the information may be stored in the divided areas that may not be entered and obtained by the other persons, and may then be copied or covered over the damaged files or discs, in order to recover the damaged files or discs right away.

Before entering into the discs 12 of the computer facilities, the users may also enter into an accelerating transmission mode 70 via the visual CPU 10, before or after the protecting mode 20 and/or the discs-and/or-files rescuing mode 30 and/or the operating system defining mode 40 and/or the buffer increasing mode 60. For example, after entering into the accelerating transmission mode 70, the users may define the data stack regions and/or may increase the acceleration transmission regions in the process 71, in order to supersede the previous data stack regions and/or the acceleration transmission regions in the discs that may have been attacked or damaged by the computer viruses.

It is to be noted that the computer facilities may become fail and may not be entered after the files and/or the discs have been attacked or damaged by the computer viruses. However, in the present invention, the files, the data, or the information or the operation systems, or the buffers or the data stack regions or the acceleration transmission regions in the discs attacked or damaged by the computer viruses may be covered or superseded by the files, the data or the information that may have previously been stored in the unformatted or unused areas of the discs or in the other hard discs and/or floppy discs, such that the files and/or the discs may be rescued or revived right away after the files or the discs have been attacked or damaged by any kind of computer viruses.

Accordingly, the method in accordance with the present invention may be used for protecting the files or information of the discs of the computer facilities, and/or for rescuing the information of files or in discs or the like after the disks or files have been damaged by the computer viruses.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for protecting original files in a disc, said method comprising:
providing a visual CPU before said disc, and
entering into said visual CPU before entering into said disc.

2. The method according to claim 1 further comprising copying the original files in said disc into a spare area as stored files.

3. The method according to claim 2 further comprising copying said stored files over said original files before entering into said disc.

4. The method according to claim 1 further comprising defining at least one operating system before entering into said disc.

5. The method according to claim 1 further comprising defining at least one buffer before entering into said disc.

6. The method according to claim 1 further comprising defining at least one data stack region before entering into said disc.

7. The method according to claim 1 further comprising defining at least one acceleration transmission region before entering into said disc.

8. A method for protecting original information in a disc, said method comprising:
providing a visual CPU before said disc,
copying the original information of said disc into a spare area as a stored information, and
entering into said visual CPU before entering into said disc.

9. The method according to claim 8 further comprising copying said stored information over said original information before entering into said disc.

10. The method according to claim 8 further comprising defining at least one operating system before entering into said disc.

11. The method according to claim 8 further comprising defining at least one buffer before entering into said disc.

12. The method according to claim 8 further comprising defining at least one data stack region before entering into said disc.

13. The method according to claim 8 further comprising defining at least one acceleration transmission region before entering into said disc.

14. A method for protecting original information in a disc, said method comprising:
providing a visual CPU before said disc,
entering into said visual CPU before entering into said disc, and
defining at least one operating system before entering into said disc.

15. The method according to claim 14 further comprising copying the original information in said disc into a spare area as stored information.

16. The method according to claim 15 further comprising copying said stored information over said original information before entering into said disc.

17. The method according to claim 14 further comprising defining at least one buffer before entering into said disc.

18. The method according to claim 14 further comprising defining at least one data stack region before entering into said disc.

19. The method according to claim 14 further comprising defining at least one acceleration transmission region before entering into said disc.
